(19) United States
(12) Patent Application Publication
(10) Pub. No.: US 2025/0069382 A1
(43) Pub. Date: Feb. 27, 2025

(54) Machine Learning Models Featuring Resolution-Flexible Multi-Axis Attention Blocks

(71) Applicant: Google LLC, Mountain View, CA (US)

(72) Inventors: Yinxiao Li, Sunnyvale, CA (US); Zhengzhong Tu, Austin, TX (US); Hossein Talebi, San Jose, CA (US); Han Zhang, Sunnyvale, CA (US); Feng Yang, Sunnyvale, CA (US); Peyman Milanfar, Menlo Park, CA (US)

(21) Appl. No.: 18/726,881

(22) PCT Filed: Jan. 5, 2023
(86) PCT No.: PCT/US2023/010207

§ 371 Date: Jul. 5, 2024

Related U.S. Application Data
(60) Provisional application No. 62/296,625, filed on Feb. 18, 2016.

(51) Int. Cl. G06V 10/82; G06V 10/764; G06V 10/77

(52) U.S. Cl. CPC G06V 10/82; G06V 10/764; G06V 10/7715

(57) ABSTRACT

Provided are machine learning systems and models featuring resolution-flexible multi-axis attention blocks. In particular, the present disclosure provides example multi-axis MLP based architectures (example implementations of which can be generally referred to as MAXIM) that can serve as an efficient and flexible general-purpose vision backbone for image processing tasks. In some implementations, MAXIM can use a UNet-shaped hierarchical structure and supports long-range interactions enabled by spatially-gated MLPs. Specifically, some example implementations of MAXIM can contain two MLP-based building blocks: a multi-axis gated MLP that allows for efficient and scalable spatial mixing of local and global visual cues, and a cross-gating block, an alternative to cross-attention, which accounts for cross-feature mutual conditioning.

### RELATED APPLICATIONS

This application claims priority to and the benefit of U.S. Provisional Patent Application No. 63/296,625, filed Jan. 5, 2022. U.S. Provisional Patent Application No. 63/296,625 is hereby incorporated by reference in its entirety.

### FIELD

The present disclosure relates generally to machine learning. More particularly, the present disclosure relates to machine learning models featuring resolution-flexible multi-axis attention blocks.

### BACKGROUND

The field of machine learning has made significant advancements on tasks relating to computer vision or other forms of image processing. For example, recent progress on Transformers (a type of neural network) and multi-layer perceptron (MLP) models have provided new network architectural designs for computer vision tasks. Although these model architectures have proved to be effective in many vision tasks such as image recognition, there remain challenges in adapting them for low-level vision. In particular, the inflexibility to support high-resolution images and limitations of local attention are perhaps the main bottlenecks for using Transformers and MLPs in image restoration or other image processing tasks in which the resolution of the input imagery is unknown and/or relatively large.

More particularly, example image processing tasks, such as restoration and enhancement, are important computer vision problems which aim to produce a desired output from a degraded input. Various types of degradations may require different image enhancement treatments, such as denoising, deblurring, super-resolution, dehazing, low-light enhancement, and so on. Given the increased availability of curated large-scale training datasets, recent high-performing approaches based on highly designed convolutional neural network (CNN) have demonstrated state-of-the-art (SOTA) performance on many tasks.

However, recent research explorations on Transformer models such as Vision Transformers (ViT) have exemplified their great potential as alternatives to the go-to CNN models. The elegance of ViT has also motivated similar model designs with simpler global operators such as MLP-Mixer, gMLP, GFNet, and FNet, to name a few. Despite successful applications to many high-level tasks, the efficacy of these global models on low-level enhancement and restoration problems has not been studied extensively.

Furthermore, the pioneering works on Transformers for low-level vision directly applied full self-attention, which only accepts relatively small patches of fixed sizes (e.g., 48×48). Such a strategy will inevitably cause patch boundary artifacts when applied on larger images using cropping. While local-attention based Transformers ameliorate this issue, they are also constrained to have limited sizes of receptive field, or to lose non-locality, which is a compelling property of Transformers and MLP models relative to hierarchical CNNs. Thus, existing Transformer and MLP-based models are not readily applicable to situations in which the resolution of the input imagery is unknown, dynamic, and/or relatively large.

### SUMMARY

Aspects and advantages of embodiments of the present disclosure will be set forth in part in the following description, or can be learned from the description, or can be learned through practice of the embodiments.

One example aspect of the present disclosure is directed to a computing system for resolution-flexible image processing. The computing system includes one or more processors; and one or more non-transitory computer-readable media that collectively store a machine-learned image processing model configured to process input image data to generate an output prediction. The machine-learned image processing model comprises one or more resolution-flexible multi-axis attention blocks. Each of the one or more resolution-flexible multi-axis attention blocks comprises: a global processing branch configured to: perform a first partitioning operation to partition at least a first portion of an input tensor of the resolution-flexible multi-axis attention block into a plurality of first feature sets, wherein the first partitioning operation generates a predefined number of the plurality of first feature sets irrespective of a resolution of the input tensor; and perform a global attention operation along a first axis of the plurality of first feature sets, wherein the first axis corresponds to the predefined number of the plurality of first feature sets; and a local processing branch configured to: perform a second partitioning operation to partition at least a second portion of the input tensor into a plurality of second feature sets; and perform a respective local attention operation on a second axis of each of the plurality of second feature sets.

Another example aspect of the present disclosure is directed to computer-implemented method for image processing. The method comprises: obtaining an input image; processing the input image with a machine-learned image processing model to generate an output prediction. Processing the input image with the machine-learned image processing model comprises, at each of one or more resolution-flexible multi-axis attention blocks of the machine-learned image processing model: at a global processing branch of the resolution-flexible multi-axis attention block: performing a first partitioning operation to partition at least a first portion of an input tensor of the resolution-flexible multi-axis attention block into a plurality of first feature sets, wherein the first partitioning operation generates a predefined number of the plurality of first feature sets irrespective of a resolution of the input tensor; and performing a global attention operation along a first axis of the plurality of first feature sets, wherein the first axis corresponds to the predefined number of the plurality of first feature sets; and at a local processing branch of the resolution-flexible multi-axis attention block: performing a second partitioning operation to partition at least a second portion of the input tensor into a plurality of second feature sets; and performing a respective local attention operation on a second axis of each of the plurality of second feature sets. The method includes providing the output prediction as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a summary of example experimental results for example embodiments of the present disclosure.

FIG. 2A depicts a graphical representation of an example MAXIM backbone according to example embodiments of the present disclosure.

FIG. 2B depicts a graphical representation of an example encoder, decoder, and/or bottleneck according to example embodiments of the present disclosure.

FIG. 2C depicts a graphical representation of an example cross gating block according to example embodiments of the present disclosure.

FIG. 3A depicts a graphical representation of an example resolution-flexible multi-axis block according to example embodiments of the present disclosure.

FIG. 3B depicts a graphical representation of an example gated MLP block according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to machine learning systems and models featuring resolution-flexible or “fully convolutional” multi-axis attention blocks. In particular, the present disclosure provides example multi-axis MLP based architectures (example implementations of which can be generally referred to as MAXIM) that can serve as an efficient and flexible general-purpose vision backbone for image processing tasks.

In some implementations, MAXIM models can use a UNet-shaped hierarchical structure and can support long-range interactions enabled by spatially-gated MLPs. Specifically, some example implementations of MAXIM can contain two MLP-based building blocks: a multi-axis gated MLP that allows for efficient and scalable spatial mixing of local and global visual cues; and a cross-gating block, an alternative to cross-attention, which accounts for cross-feature mutual conditioning. In some implementations, both of these building blocks can be exclusively based on MLPs, but also benefit from being both global and “fully-convolutional,” two properties that are desirable for image processing.

Example implementations of the proposed MAXIM model achieve state-of-the-art performance on more than ten benchmarks across a range of image processing tasks, including denoising, deblurring, deraining, dehazing, and enhancement, all while requiring fewer or comparable numbers of parameters and FLOPs than competitive models. Therefore, the proposed systems and models both improve the performance of a computer on various image processing tasks and also conserve computational resources such as processor usage, memory usage, latency, network bandwidth usage, etc.

More particularly, as described above, Transformers and similar models are not readily applicable to situations in which the resolution of the input imagery is unknown, changing, and/or relatively large. In particular, the inflexibility to support high-resolution images and limitations of local attention are perhaps the main bottlenecks for using Transformers and MLPs in image restoration or other image processing tasks in which the resolution of the input imagery is unknown, changing, and/or relatively large.

To overcome these issues, the present disclosure proposes a generic image processing network, example implementations of which can be referred to MAXIM, for low-level vision tasks. A key design element of MAXIM is the use of a multi-axis approach that captures both local and global interactions in parallel. The multi-axis approach can mix information on a single axis for each branch.

In particular, according to an aspect of the present disclosure, the global branch of the multi-axis block can include a partitioning operation that generates a predefined number of feature sets from an input tensor, irrespective of a resolution of the input tensor. As one example, the partitioning operation can be a grid operation that partitions the input tensor into a grid having the predefined number of feature sets. In such fashion, the corresponding gating and/or attention operations (e.g., processing with a gated MLP) can be performed on a fixed amount of data (e.g., a set of feature values including one respective representative feature value from each of the predefined number feature sets). In such fashion, the global branch of the multi-axis block can be resolution-flexible or “fully convolutional.” Stated differently, the global branch of the multi-axis block can automatically scale to handle differing resolutions of input images (and corresponding intermediate tensors generated from processing of the input image). Specifically, example implementations of the proposed multi-axis block are “fully-convolutional” and scale linearly with respect to image size, which significantly increases its flexibility for dense image processing tasks.

Thus, one example aspect of the present disclosure is a novel approach for applying both local and global attention in parallel, where the global attention mechanism is resolution-flexible (e.g., can easily or automatically scale when the resolution of the input image is increased). In particular, provided is a multi-axis gated MLP block tailored for low-level vision tasks, which always enjoys a global receptive field, with linear complexity relative to image size. This is in contrast to certain existing approaches which rely on attention operations (e.g., global block-based operations) that are resolution-inflexible (i.e., that do not easily or automatically scale when the resolution of the input image is increased). As such, these existing approaches are limited to situations in which the input imagery as a known resolution which is relatively small.

The present disclosure also provides a cross-gating block (e.g., a pure MLP-based cross-gating block), which adaptively gates the skip-connections in the neck of MAXIM using the same multi-axis approach, and which further boosts performance. This cross gating block can cross-conditions on two separate feature streams, and is also global and fully-convolutional, as described above. Thus, another example aspect of the present disclosure is directed to a cross-gating block that relies upon the resolution-flexible multi-axis approach to perform gating on one feature stream based on gating weights generated from another, different feature stream.

Using these building blocks, the present disclosure also provides an effective multi-stage, multi-scale architecture consisting of a stack of MAXIM backbones. This novel and generalized architecture for image processing, which uses a stack of encoder-decoder backbones, can be supervised by a multi-scale, multi-stage loss. Example implementations of this MAXIM architecture are shown experimentally in U.S. Provisional Patent Application No. 63/296,625 to achieve strong performance on a range of image processing tasks, while requiring very few number of parameters and FLOPs.

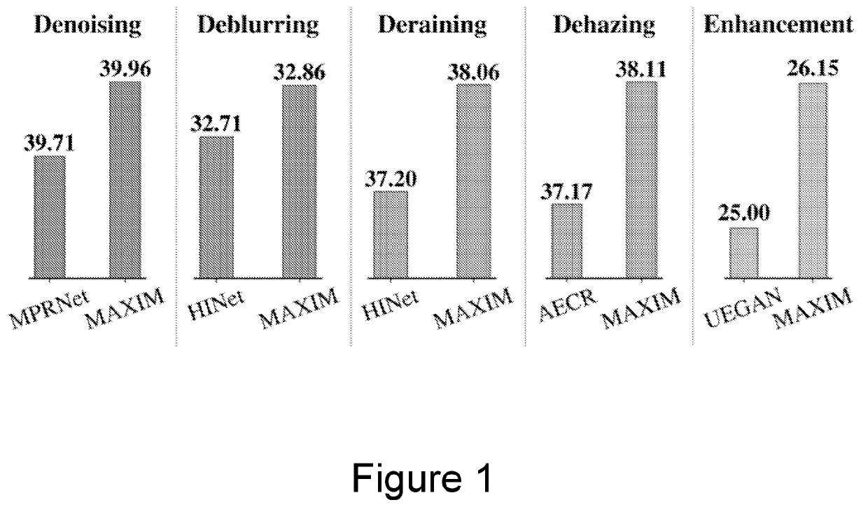

The present disclosure provides a number of technical effects and benefits. As one example, extensive experiments show that example implementations of MAXIM achieve SOTA results on more than 10 datasets including denoising, deblurring, deraining, dehazing, and enhancement. FIG. 1 depicts a summary of example experimental results for example embodiments of the present disclosure. As shown in FIG. 1, example implementations of proposed MAXIM model significantly advances state-of-the-art performance on five image processing tasks in terms of PSNR: 1) Denoising (+0.24 dB on SIDD), 2) Deblurring (+0.15 dB on GoPro) 3) Deraining (+0.86 dB on Rain100L), 4) Dehazing (+0.94 dB on RESIDE), and 5) Retouching (Enhancement) (+1.15 dB on FiveK). Thus, the proposed systems and models provide improved computer performance on a significant number of different image processing tasks. Therefore, the present disclosure represents an improvement in the performance of a computer itself as relates to a specific technical purpose (e.g., image processing tasks such as image enhancement).

As another example technical effect and benefit, the model architectures described herein provide superior performance even with fewer parameters and/or FLOPs. Thus, relative to existing approaches, the proposed models can perform the same tasks with superior outcomes while expending fewer computational resources. Therefore, the proposed systems and models conserve computational resources such as processor usage, memory usage, network bandwidth, etc. As such, the proposed techniques correspond to a specific technical implementation that has a design that is motivated by technical considerations of the internal functioning of the computer.

As another example technical effect, the model architectures described herein are resolution-flexible. As such, only a single model may need to be trained which can handle multiple different resolutions. Previous approaches require multiple different models to handle multiple different resolutions. By enabling training and storage of a single model versus multiple models, the proposed approaches result in savings of processor usage, memory usage, network bandwidth etc. Thus, the proposed techniques correspond to a specific technical implementation that has a design that is motivated by technical considerations of the internal functioning of the computer.

With reference now to the Figures, example embodiments of the present disclosure will be discussed in further detail.

### Example MAXIM Models

The present disclosure presents the first effective general-purpose MLP architecture for low-level vision, which can be referred to as Multi-AXis MLP for IMage processing (MAXIM). Unlike previous low-level Transformers, MAXIM has several desired properties, making it intriguing for image processing tasks. First, MAXIM expresses global receptive fields on arbitrarily large images with linear complexity; Second, it directly supports arbitrary input resolutions, i.e., being fully-convolutional; Lastly, it provides a balanced design of local (Conv) and global (MLP) blocks, outperforming SOTA methods without the necessity for large-scale pre-training. As used herein, the term block corresponds to a defined structure or architecture of a component portion of a machine learning model.

### Example Main Backbone

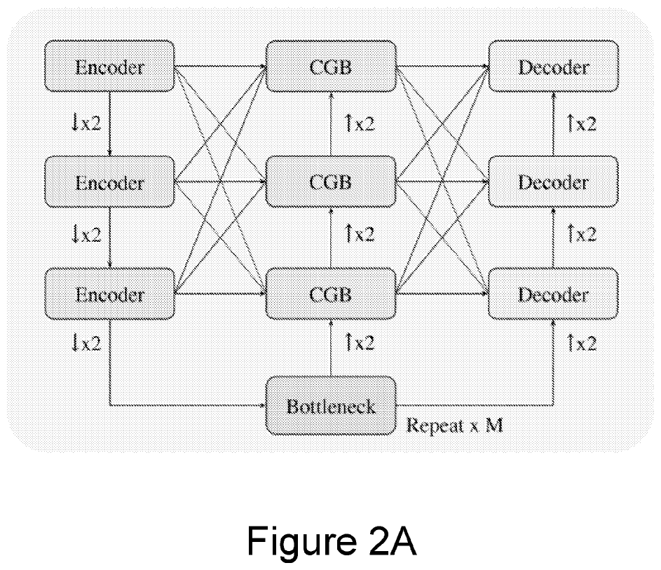

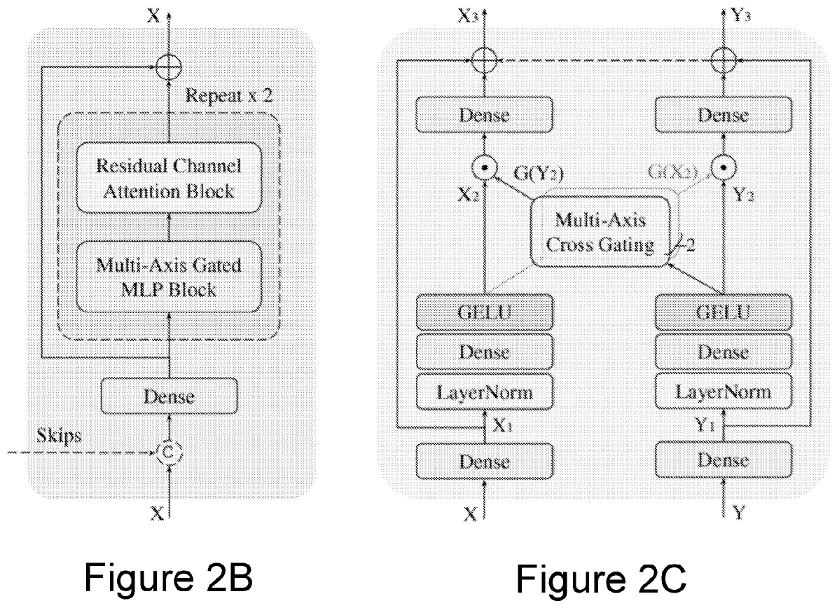

In some examples, the MAXIM backbone follows the encoder-decoder design principles that originated with UNet. As one example, FIG. 2A depicts a graphical representation of an example MAXIM backbone according to example embodiments of the present disclosure. As illustrated in FIG. 2A, the example MAXIM backbone includes a number (e.g., shown here as three, but it can be any number) of encoders and a number (e.g., shown here as three, but it can be any number) of decoders. The encoders can be arranged in a sequence and each encoder in the sequence can include a downsizing of the input (e.g., by a factor of two). The decoders can be arranged in a sequence and each decoder in the sequence can include an upsizing of the input (e.g., by a factor of two). A bottleneck block can exist between the final encoder in the encoder sequence and the first decoder in the decoder sequence.

As one example, each of the encoders, the bottleneck block and/or each of the decoders can have an architecture or arrangement as shown in FIG. 2B, which shows one example architecture that can be used for the encoder, bottleneck, and/or decoder. Operators having small footprints such as Conv3×3 have been shown to contribute to the performance of UNet-like networks. Thus, some example implementations of the present disclosure use on a hybrid model design for each block—convolutional operations (“Conv”) for local processing or attention, and MLP for long-range interactions or attention.

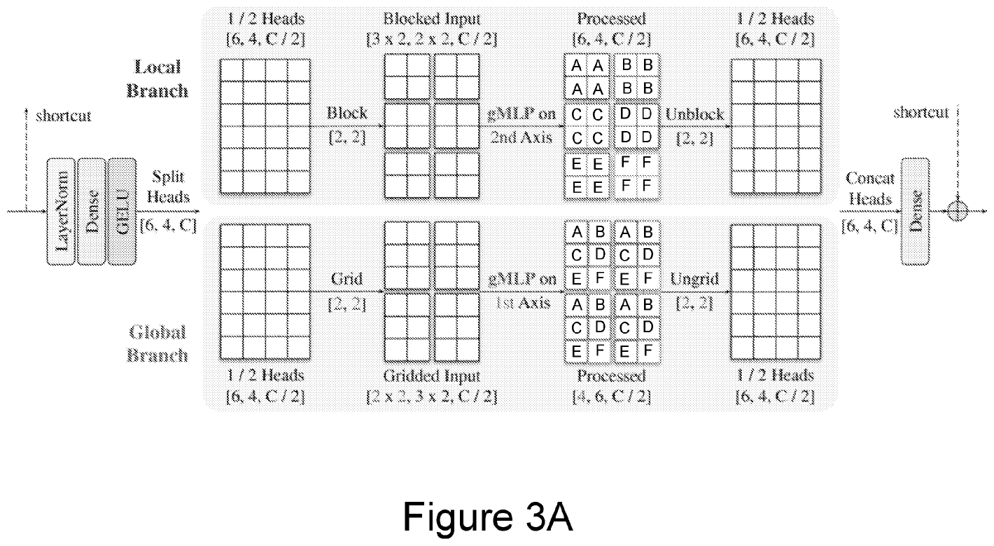

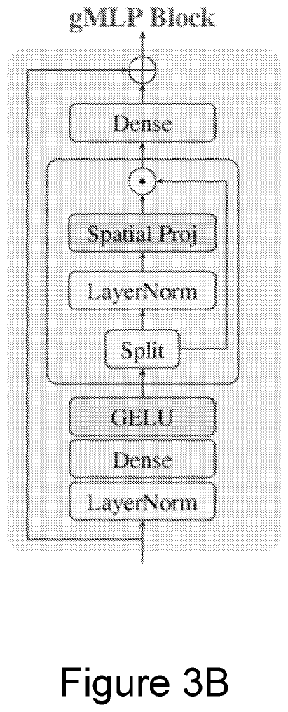

To allow long-range spatial mixing at different scales, example implementations of the present disclosure insert the proposed multi-axis gated MLP block (MAB) (discussed in further detail in the following subsection) into each encoder, decoder, and bottleneck, with a residual channel attention block (RCAB) stacked subsequently. As an example, the example architecture shown in FIG. 2B includes a multi-axis block (e.g., a multi-axis gated MLP block). An example multi-axis block is shown in FIG. 3A and will be discussed in further detail in the following subsection. The example architecture shown in FIG. 2B also includes a residual channel attention block, as described in Woo et al., Cbam: Convolutional block attention module. In ECCV, pages 3-19, 2018 and Zamir et al., Multi-stage progressive image restoration. In CVPR, pages 14821-14831, 2021. See also, He et al., Squeeze-and-excitation networks. In Proceedings of the IEEE conference on computer vision and pattern recognition, pages 7132-7141, 2018.

Example implementations of the present disclosure also extend the gated MLP (gMLP) to build a cross gating block, which is an efficient 2nd-order alternative to cross-attention (3rd-order correlations), to interact, or condition two distinct features. Example implementations of the present disclosure also leverage the global features from the Bottleneck to gate the skip connections, while propagating the refined global features upwards to the next CGB.

As an example, referring again in FIG. 2A, a number of cross gating blocks (CGB) can be positioned along skip connections between encoders and decoders. In some examples, as shown, each cross gating block can: receive inputs from all encoders and a cross gating block of lower resolution; and providing outputs to all decoders. Thus, multi-scale feature fusion (red and blue lines) can be utilized to aggregate multi-level information in the Encoder→CGB and CGB→Decoder dataflow. An example structure for each cross gating block is shown in FIG. 2C. The block structure shown in FIG. 2C includes a multi-axis cross gating block. This multi-axis cross gating block can have an architecture that is similar to the architectures shown in FIGS. 3A and 3B, except that the gating weights can be applied to a different feature stream, as discussed further below.

Referring again to FIG. 2A, the input to the MAXIM backbone can be provided at the first encoder in the encoder sequence (shown at the top left). The output from the MAXIM backbone can be provided from the final decoder in the decoder sequence (shown at the top right). In some implementations, multiple MAXIM backbones (the structure shown in FIG. 2A) can be repeated in a sequence one after the other (e.g., for M times) to create a larger backbone for a larger model.

### Example Multi-Axis Gated MLP

While certain existing approaches are capable of performing attention on more than a single axis, in such existing approaches, attention is performed on two axes on blocked images. Thus, the attention operations in the existing approaches correspond to two forms of sparse self-attention, namely regional and dilated attention. Despite capturing local and global information in parallel, these existing approaches cannot accommodate image restoration or enhancement tasks where the test images are often of arbitrary sizes.

The present disclosure improves the ‘multi-axis’ concept for image processing tasks, by building a (e.g., split-head) multi-axis gated MLP block (MAB) that is resolution-flexible. In particular, instead of applying multi-axis attention on a single partitioning of the input tensor, the proposed MAB includes two branches which each are partitioned independently. In some implementations, the two branches may each correspond to one-half of the “heads” of the MAB, and each of the branches may process one-half of the input tensor that is provided to the MAB. However, in other implementations, other ratios (e.g., one-quarter to three-quarters) may be used; the respective portions of the input tensor that are processed by the branches may be overlapping; and/or each branch may process an entirety of the input tensor. For ease of explication, the remainder of this section will describe the MAB with the half-head arrangement, but it should be noted that other arrangements are possible.

In the local branch shown in the top half of FIG. 3A, a half portion of the input tensor having a size (H, W, C/2) is blocked into a tensor of shape

$$( \frac{H}{b} \times \frac{W}{b} , b \times b , C / 2 ) ,$$

representing partitioning into non-overlapping windows each with size of (b×b). In the global branch, which is shown in the bottom half of FIG. 3A, the other half portion of the input tensor is gridded into the shape

$$( d \times d , \frac{H}{d} \times \frac{W}{d} , C / 2 )$$

using a fixed (d×d) grid, with each window having size

$$( \frac{H}{b} \times \frac{W}{b} ) .$$

Thus, in the global branch, a partitioning operation is applied that results in generation of a predefined number of feature sets, irrespective of the resolution (e.g., the H, W) of the input tensor. This enables the global branch to automatically scale to handle inputs of any different resolution.

For the example in FIG. 3A, b=2, d=2; however these values are simply used as examples for the purpose of illustration. To make it fully-convolutional, the MAB shown in FIG. 3A applies the gated MLP (gMLP) block (e.g., as shown in FIG. 3B) on a single axis of each branch—the 2nd axis for the local branch and the 1st axis for the global branch—while sharing parameters on the other spatial axes. Applying multi-axis gMLPs in parallel corresponds to local and global (dilated) mixing of spatial information, respectively. Thus, the proposed block expresses both global and local receptive fields on arbitrary input resolutions.

More particularly, as shown in FIG. 3A, the resolution-flexible multi-axis attention blocks can include a global processing branch and a local processing branch. The global processing branch can be configured to perform a first partitioning operation to partition at least a first portion (e.g., half) of an input tensor of the resolution-flexible multi-axis attention block into a plurality of first feature sets. In particular, the first partitioning operation can generate a predefined number of the plurality of first feature sets irrespective of a resolution of the input tensor. As an example, in FIG. 3A, a grid operation is performed that partitions the first portion of the input tensor into a grid, creating the predefined number (e.g., 2×2, four) of first feature sets. In FIG. 3A, the first feature sets each have a 3×2 shape. The global processing branch can also be configured to perform a global attention operation along a first axis of the plurality of first feature sets, where the first axis corresponds to the predefined number of the plurality of first feature sets. Specifically, in some implementations, performing the global attention operation can include, for each of a number of positions within each first feature set, processing a respective feature value from each of the plurality of first feature sets with a gMLP or other operation, as discussed further below.

To provide an example, in the example shown in FIG. 3A, in the first feature sets of the global branch, there are six positions in each of the four first feature sets. To perform the global operation: the top left value from each of the four first feature sets can be collectively processed; the top right value from each of the four first feature sets can be collectively processed; the middle left value from each of the four first feature sets can be collectively processed; the middle right value from each of the four first feature sets can be collectively processed; the bottom left value from each of the four first feature sets can be collectively processed; and the bottom right value from each of the four first feature sets can be collectively processed.

Referring still to FIG. 3A, the resolution-flexible multi-axis attention blocks can also include a local processing branch. The local processing branch can be configured to perform a second partitioning operation to partition at least a second portion (e.g., the other half) of the input tensor into a plurality of second feature sets. For example, the second partitioning operation can be a block partitioning operation that partitions the second portion of the input tensor into a plurality of second feature sets such that each of the plurality of second feature sets has a predefined height and width.

As an example, in FIG. 3A, block grid operation is performed that partitions the second portion of the input tensor into a number of blocks, thereby creating six blocks that each have a predefined height and width (e.g., 2×2). In FIG. 3A, the second feature sets each have the predefined 2×2 shape.

The local processing branch can also be configured to perform a local attention operation along a second axis of the plurality of first feature sets. For example, the second axis can correspond to the height and width of the second feature sets. Specifically, in some implementations, performing the local attention operation can include, for each of the second feature sets, processing all feature values within the second feature set with a gMLP or other operation, as discussed further below.

To provide an example, in the example shown in FIG. 3A, there are six second feature sets. To perform the local operation all values included in each of the second feature sets can be processed independent of the other second feature sets. For example, the four values of the top left second feature set can be processed; the four values of the top right second feature set can be processed, the four values of the middle left second feature set can be processed, and so on.

In some implementations, the predefined number of the plurality of first feature sets is equal to a multiplication of the predefined height and width of each of the plurality of second feature sets. This can enable increased parameter or architecture sharing. As example, as shown in FIG. 3A, the predefined number of the first feature sets (4) can equal the multiplication of the predefined height and width of each of the plurality of second feature sets (2×2=4).

After processing occurs in each branch, the processed heads are concatenated and projected to reduce the number of channels, which are further combined using the long skip-connection from the input. It is worth noting that this approach provides an advantage for the proposed model over methods that process fixed-size image patches by avoiding patch boundary artifacts.

Complexity analysis: The computational complexity of the proposed Multi-Axis gMLP block (MAB) is:

$$Ω ( MAB ) = {\underbrace{{b}^{2} HWC}}_{Global gMLP} + {\underbrace{{d}^{2} HWC}}_{Local gMLP} + {\underbrace{10 {HWC}^{2}}}_{Dense layers} , \qquad ( 1 )$$

which is linear with respect to image size HW, while other global models like ViT, Mixer, and gMLP are quadratic.

Universality of the multi-axis approach: The proposed parallel multi-axis block (FIG. 3A) presents a principled way to apply 1D operators on 2D images in a scalable manner. It also allows for significant flexibility and universality. For example, a straightforward replacement of a gMLP with a spatial MLP (e.g., Tolstikhin et al., MLP-Mixer: An all-MLP architecture for vision. arXivpreprint arXiv:2105.01601, 2021), self-attention (e.g., Dosovitskiy et al., An image is worth 16×16 words: Transformers for image recognition at scale. In ICLR, 2021), or even Fourier Transform (e.g., Lee-Thorp et al., Fnet: Mixing tokens with Fourier Transorms. arXiv preprint arXiv: 2105.03824, 2021 and Rao et al., Global filter networks for image classification. arXivpreprint arXiv:2107.00645, 2021) leads to a family of MAXIM variants, all sharing globality and fully-convolutionality. It is also easily extensible to any future 1D operator that may be defined on, e.g., Language models. Thus, while FIG. 3A shows application of a gMLP on the partitioned feature sets, other processing operations can be performed instead, such as spatial MLP, self-attention, Fourier Transform, or other operations such as other 1D operators.

GatedMulti Layer Perceptron: FIG. 3B shows an example architecture for a gMLP. In the illustration of FIG. 3B, a series of layers shown as ‘Split’, ‘LayerNorm’, and ‘Spatial Projection’ can be used to generate a set of gating weights from a set of input feature values. The example shown in FIG. 3B includes a residual connection from the ‘Split’ layer to the output of the ‘Spatial Projection’ layer corresponds to using the gating weights to gate the same set of input feature values. Thus, the gated multi-layer perceptron block generates one or more gating weights for input feature values, and the gated multi-layer perceptron block applies the one or more gating weights to gate the input feature values. This arrangement can be used in the MAB in an encoder, decoder, and/or bottleneck of the model.

In an alternative arrangement that can be used in the cross gating block (described in further detail in the next section), the residual from the ‘Split’ layer can instead be transmitted to a different gMLP block that has a different set of feature values as an input. Thus, the gated multi-layer perceptron block can generate one or more gating weights for input feature values, and the gated multi-layer perceptron block can apply the one or more gating weights to gate other feature values associated with a different feature stream.

### Example Cross Gating MLP Block

A common improvement over UNet is to leverage contextual features to selectively gate feature propagation in skip-connections, which is often achieved by using cross-attention. Here, example implementations of the present disclosure include an effective alternative, namely cross-gating block, as an extension of MAB which typically only processes a single feature. CGB can be regarded as a more general conditioning layer that interacts with multiple features. Example implementations of the CGB can follow similar design patterns as those used in MAB. FIG. 2C provides an example architecture for the CGB.

To be more specific, let X, Y be two input features, and X₁, Y₁ ∈ [symbol] ^{H×W×C} be the features projected after the first Dense layers in FIG. 2C. Input projections are then applied:

$${X}_{2} = σ ( {W}_{1} LN ( {X}_{1} ) ) , {Y}_{2} = σ ( {W}_{2} LN ( {Y}_{1} ) ) \qquad ( 2 )$$

where σ is the GELU activation, LN is Layer Normalization, and W₁, W₂ are MLP projection matrices. The multi-axis blocked gating weights are computed from X₂, Y₂, respectively, but applied reciprocally:

$$\hat{X} = {X}_{2} ⊙ G ( {Y}_{2} ) , \hat{Y} = {Y}_{2} ⊙ G ( {X}_{2} ) \qquad ( 3 )$$

where ⊙ represents element-wise multiplication, and the function G(·) extracts multi-axis cross gating weights from the input using the proposed multi-axis approach:

$$G ( x ) = {W}_{5} ( [ {W}_{3} {Block}_{b} ( {z}_{1} ) , {W}_{4} {Grid}_{d} ( {z}_{2} ) ] ) \qquad ( 4 )$$

where [·,·] denotes concatenation. Here (z₁, z₂) are two independent heads split from z along the channel dimension, where z represents the projected features x after activation:

$$[ {z}_{1} , {z}_{2} ] = z = σ ( {W}_{6} LN ( x ) ) , \qquad ( 5 )$$

and W₃, W₄ are spatial projection matrices applied on the 2nd and 1st axis of the blocked/gridded features having fixed window size b×b (Block_{b}), and fixed grid size of d×d (Grid_{d}), respectively. Finally, residual connections are adopted from the inputs, following an output channel-projection that maintains the same channel dimensions as the inputs (X₁, Y₁), using projection matrices W₇, W₈, denoted by

$${X}_{3} = {X}_{1} + {W}_{7} \hat{X} , {Y}_{3} = {Y}_{1} + {W}_{8} \hat{Y} . \qquad ( 6 )$$

The complexity of CGB is also tightly-bounded by Equation 1.

### Example Multi-Stage Multi-Scale Framework

According to another aspect, some example models of the present disclosure can further adopt a multi-stage framework, which is more effective, as compared to scaling up the model width or height. Full resolution processing can be a better approach than a multi-patch hierarchy, since the latter would potentially induce boundary effects across patches. To impose stronger supervision, a multi-scale approach can be applied at each stage to help the network learn. The supervised attention block can be leveraged to propagate attentive feature maps progressively along the stages. The proposed cross-gating block can be used for any cross-stage feature fusion.

Formally, given an input image I∈ [symbol] ^{H×W×3}, some example implementations first extract multi-scale variants of the image by downscaling: Iₙ, n=1, . . . , N. MAXIM can be configured to predict multi-scale restored outputs at each stage s of S stages, yielding a total of S×N outputs: R_{s,n}. Despite being multi-stage, MAXIM can, in some implementations, be trained end-to-end with losses accumulating across stages and scales:

$$ℒ = {\sum }_{s = 1}^{S} {{\sum }_{n = 1}}^{N} [ {ℒ}_{char} ( {R}_{s , n} , {T}_{n} ) + λ {ℒ}_{freq} ( {R}_{s , n} , {T}_{n} ) ] , \qquad ( 7 )$$

where Tₙ denotes (bilinearly-rescaled) multi-scale target images, and [symbol] _{char} is the Charbonnier loss:

$${ℒ}_{char} ( R , T ) = \sqrt{{‖ R - T ‖}^{2} + {ε}^{2}} , \qquad ( 8 )$$

where it is set ε=10⁻³. [symbol] _{freq} is the frequency reconstruction loss that enforces high-frequency details:

$${ℒ}_{freq} ( R , T ) = {‖ ℱ ( R ) - ℱ ( T ) ‖}_{1} \qquad ( 9 )$$

where [symbol] (·) represents the 2D Fast Fourier Transform. In one example, λ=0.1 can be used as the weighting factor, as was done in all experiments.

### Example Devices and Systems

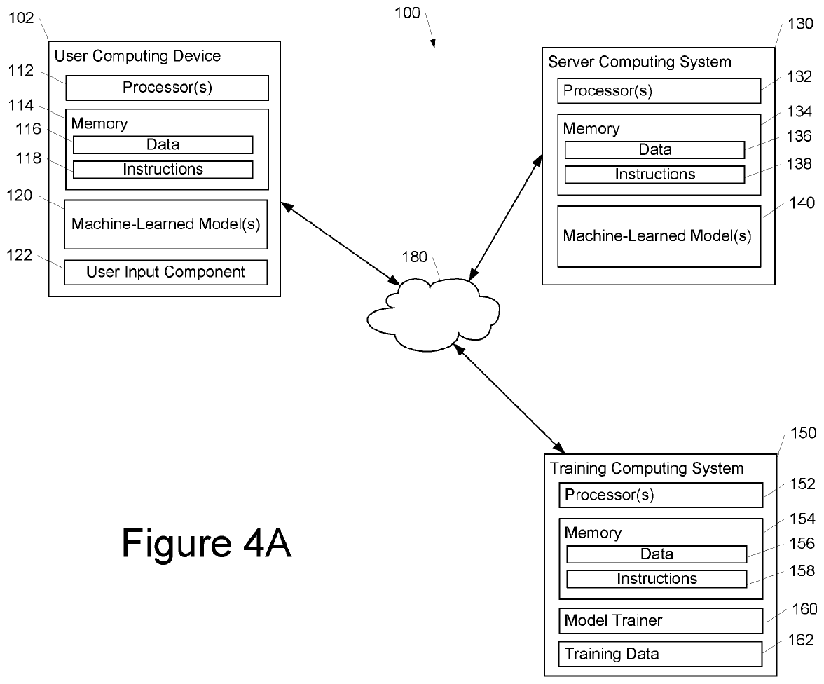

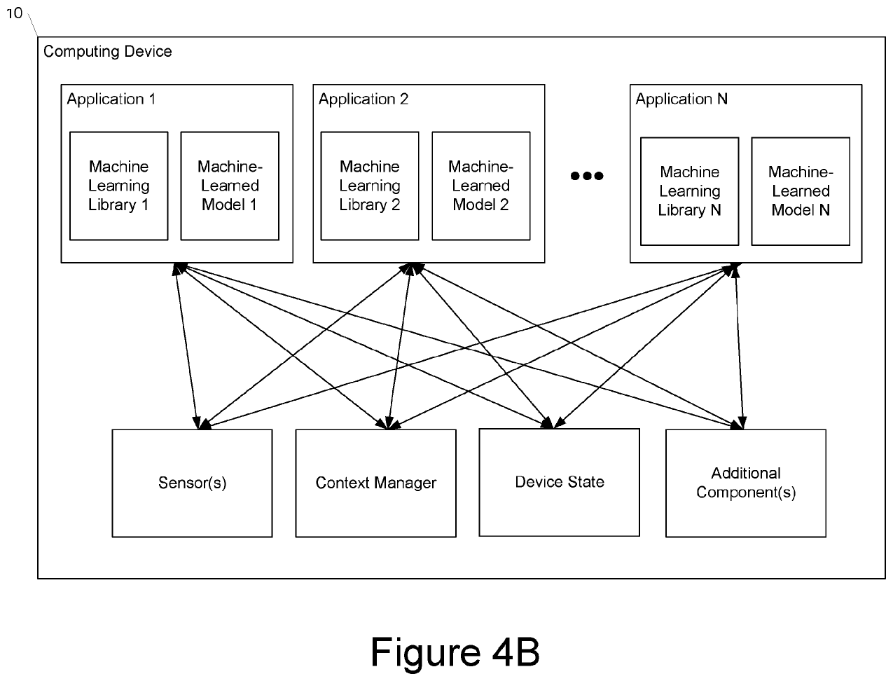

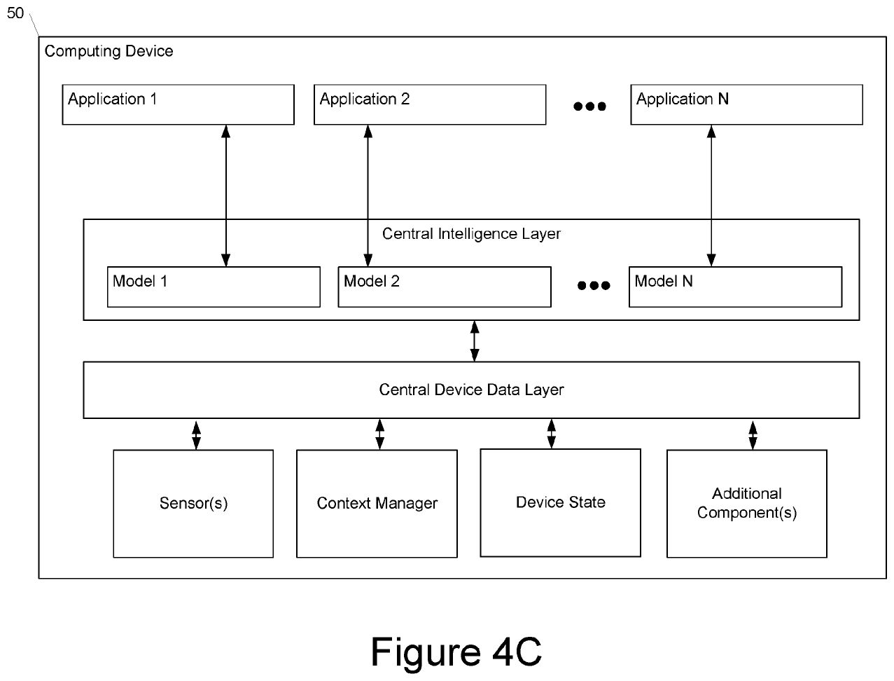

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as attention. For example, some example machine-learned models can include multi-headed attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image processing across multiple instances of input).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image processing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as attention. For example, some example machine-learned models can include multi-headed attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, image training pairs, where each training pair includes a training image and a desired output. The desired output can be a label, a classification, and/or an output image (e.g., a reconstructed image).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for resolution-flexible image processing, the computing system comprising:
one or more processors; and
one or more non-transitory computer-readable media that collectively store:
a machine-learned image processing model configured to process input image data to generate an output prediction, wherein the machine-learned image processing model comprises one or more resolution-flexible multi-axis attention blocks, each of the one or more resolution-flexible multi-axis attention blocks comprising:
a global processing branch configured to:
perform a first partitioning operation to partition at least a first portion of an input tensor of the resolution-flexible multi-axis attention block into a plurality of first feature sets, wherein the first partitioning operation generates a predefined number of the plurality of first feature sets irrespective of a resolution of the input tensor; and
perform a global attention operation along a first axis of the plurality of first feature sets, wherein the first axis corresponds to the predefined number of the plurality of first feature sets; and
a local processing branch configured to:
perform a second partitioning operation to partition at least a second portion of the input tensor into a plurality of second feature sets; and
perform a respective local attention operation on a second axis of each of the plurality of second feature sets.

2. The computing system of claim 1, wherein the input tensor has a height, a width, and a channel depth, and wherein the first partitioning operation comprises a grid partitioning operation that partitions the height and width of the input tensor into a grid having the predefined number of the plurality of first feature sets.

3. The computing system of claim 1, wherein the second partitioning operation comprises a block partitioning operation that partitions the second portion of the input tensor into the plurality of second feature sets such that each of the plurality of second feature sets has a predefined height and width.

4. The computing system of claim 3, wherein the predefined number of the plurality of first feature sets is equal to a multiplication of the predefined height and width of each of the plurality of second feature sets.

5. The computing system of claim 1, wherein:
performing the global attention operation comprises, for each of a number of positions within each first feature set, processing a respective feature value from each of the plurality of first feature sets with a gated multi-layer perceptron block; and
performing the local attention operation comprises, for each of the second feature sets, processing all feature values within the second feature set with the gated multi-layer perceptron block.

6. The computing system of claim 5, wherein the gated multi-layer perceptron block generates one or more gating weights for input feature values, and wherein the gated multi-layer perceptron block applies the one or more gating weights to gate the input feature values.

7. The computing system of claim 5, wherein the gated multi-layer perceptron block generates one or more gating weights for input feature values, and wherein the gated multi-layer perceptron block applies the one or more gating weights to gate the other feature values associated with a different feature stream.

8. The computing system of claim 1, wherein:
performing the global attention operation comprises, for each of a number of positions within each first feature set, processing a respective feature value from each of the plurality of first feature sets with one of the following: a spatial multi-layer perceptron, self-attention, or a Fourier transform; and
performing the local attention operation comprises, for each of the second feature sets, processing all feature values within the second feature set with one of the following: a spatial multi-layer perceptron, self-attention, or a Fourier transform.

9. The computing system of claim 1, wherein the first portion of the input tensor comprises a first half of a plurality of depth channels of the input tensor and the second portion of the input tensor comprises a second half of the plurality of depth channels of the input tensor.

10. The computing system of claim 1, wherein:
the one or more resolution-flexible multi-axis attention blocks comprises a plurality of resolution-flexible multi-axis attention blocks;
the machine-learned image processing model comprises one or more backbone blocks, each of the one or more backbone blocks comprising a hierarchical structure of a plurality of encoders and a plurality of decoders; and
each of the plurality of encoders and each of the plurality of decoders contains a respective one of the plurality of resolution-flexible multi-axis attention blocks.

11. The computing system of claim 10, wherein the machine-learned image processing model comprises a plurality of backbone blocks arranged in a sequence one after the other.

12. The computing system of claim 10, wherein, for each backbone block, the hierarchical structure of the plurality of encoders and the plurality of decoders is trained with loss accumulating across multiple scales of the plurality of encoders and the plurality of decoders.

13. The computing system of claim 1, wherein the output prediction comprises an image classification prediction, an image recognition prediction, or an object recognition prediction.

14. The computing system of claim 1, wherein the output prediction comprises a restored image, the restored image having been one or more of: denoised, deblurred, derained, dehazed, or retouched.

15. A computer-implemented method for image processing, the method comprising:
obtaining an input image;
processing the input image with a machine-learned image processing model to generate an output prediction, wherein processing the input image with the machine-learned image processing model comprises, at each of one or more resolution-flexible multi-axis attention blocks of the machine-learned image processing model:
at a global processing branch of the resolution-flexible multi-axis attention block:
performing a first partitioning operation to partition at least a first portion of an input tensor of the resolution-flexible multi-axis attention block into a plurality of first feature sets, wherein the first partitioning operation generates a predefined number of the plurality of first feature sets irrespective of a resolution of the input tensor; and
performing a global attention operation along a first axis of the plurality of first feature sets, wherein the first axis corresponds to the predefined number of the plurality of first feature sets; and
at a local processing branch of the resolution-flexible multi-axis attention block:
performing a second partitioning operation to partition at least a second portion of the input tensor into a plurality of second feature sets; and
performing a respective local attention operation on a second axis of each of the plurality of second feature sets; and
providing the output prediction as an output.

16. The computer-implemented method of claim 15, wherein the input tensor has a height, a width, and a channel depth, and wherein the first partitioning operation comprises a grid partitioning operation that partitions the height and width of the input tensor into a grid having the predefined number of the plurality of first feature sets.

17. The computer-implemented method of claim 16, wherein the second partitioning operation comprises a block partitioning operation that partitions the second portion of the input tensor into the plurality of second feature sets such that each of the plurality of second feature sets has a predefined height and width.

18. The computer-implemented method of claim 17, wherein the predefined number of the plurality of first feature sets is equal to a multiplication of the predefined height and width of each of the plurality of second feature sets.

19. The computer-implemented method of claim 15, wherein:
performing the global attention operation comprises, for each of a number of positions within each first feature set, processing a respective feature value from each of the plurality of first feature sets with a gated multi-layer perceptron block; and
performing the local attention operation comprises, for each of the second feature sets, processing all feature values within the second feature set with the gated multi-layer perceptron block.

20. The computer-implemented method of claim 15, wherein:
performing the global attention operation comprises, for each of a number of positions within each first feature set, processing a respective feature value from each of the plurality of first feature sets with one of the following: a spatial multi-layer perceptron, self-attention, or a Fourier transform; and
performing the local attention operation comprises, for each of the second feature sets, processing all feature values within the second feature set with one of the following: a spatial multi-layer perceptron, self-attention, or a Fourier transform.
